(19) United States
(12) Patent Application Publication
(10) Pub. No.: US 2017/0196656 A1
(43) Pub. Date: Jul. 13, 2017

(54) STRIPPING TIP FOR ORTHODONTICS AND MANUFACTURING METHOD THEREOF

(71) Applicant: SGM KOREA CO.,LTD., Seoul (KR)

(72) Inventors: Sang-Nam SHIN, Uijeongbu-si (KR); Hyun-Min MO, Goyang-si (KR)

(21) Appl. No.: 15/162,124

(22) Filed: May 23, 2016

(30) Foreign Application Priority Data
Jan. 11, 2016 (KR) 10-2016-0003071

(51) Int. Cl. A61C 3/12; B21K 5/00; A61C 7/02

(52) U.S. Cl. CPC A61C 3/12; A61C 7/02; B21K 5/00

(57) ABSTRACT

The present invention relates to a stripping tip for orthodontics and a manufacturing method thereof. The stripping tip includes a grinding blade provided with a grinding surface for grinding teeth, a holder comprising a grinding blade coupling portion coupled to the grinding blade and a connection coupling portion connected to the grinding blade coupling portion and coupled to a handle or handpiece, and a stiffness enhancement portion provided to a part of the grinding blade coupling portion coupled to the grinding blade to enhance stiffness of the part of the grinding blade coupling portion coupled to the grinding blade.

### BACKGROUND

1. Technical Field

The present invention relates to a stripping tip for orthodontics and a manufacturing method thereof and, more particularly, a stripping tip for orthodontics in which is used to secure space for a tooth during orthodontic treatment and a manufacture method thereof.

2. Description of the Related Art

Techniques for orthodontics may be divided into a “metal brace” technique which employs an orthodontic appliance in the form of a metal bracket, “lingual brace” technique which applies an orthodontic appliance to the inner side of teeth and “transparent brace” technique for mounting a transparent brace formed of a transparent material on teeth.

In particular, in the transparent brace technique, a brace formed of a transparent material covers teeth like a mouse pad, and thus is invisible from the outside. In addition, the brace is detachable and is thus very convenient to put on teeth. For these reasons, the transparent brace technique has drawn great attention, compared to the other orthodontic techniques.

According to the conventional transparent brace technique, when a dentist requests fabrication of a transparent brace, an orthodontic data generation apparatus generates data of multiple corrected teeth according to gradual shift of the teeth based on the data of the teeth of a patient obtained through 3D scanning with a 3D scanner, and a teeth mold is fabricated by 3D-printing the generated corrected teeth data. Thereafter, a transparent brace is fabricated in multiple steps by attaching a transparent film to the teeth mold through a vacuum compressor.

Herein, if a space for gradual shift of the teeth is not secured, the teeth cannot be shifted. Accordingly, in some cases, the stripping process of grinding boundary surfaces of teeth to secure a space for shift of the teeth may be essentially involved.

The stripping process may be performed using a stripper for orthodontics which includes a stripping tip configured to grind boundary surfaces of teeth and a handle coupled to the stripping tip.

A conventional technology of the background art of the present invention is disclosed in Korean Patent No. 10-1218389 (Issue date: Dec. 27, 2012; Invention title: A TEETH STRIPPING CONTROLLER FOR ORTHODONTICS CAPABLE OF PRECISELY CONTROLLING TEETH STRIPPING).

### SUMMARY

It is an aspect of the present invention to provide a stripping tip for orthodontics provided with an improved structure to effectively increase the overall length and stroke and a manufacturing method thereof.

In accordance with one aspect of the present invention, a stripping tip for orthodontics includes a grinding blade provided with a grinding surface for grinding teeth, a holder including a grinding blade coupling portion coupled to the grinding blade and a connection coupling portion connected to the grinding blade coupling portion and coupled to a handle or handpiece, and a stiffness enhancement portion provided to a part of the grinding blade coupling portion coupled to the grinding blade to enhance stiffness of the part of the grinding blade coupling portion coupled to the grinding blade.

Preferably, the stiffness enhancement portion is formed by performing pressure forging on a surface of the grinding blade coupling portion coupled to the grinding blade.

Preferably, the stiffness enhancement portion is formed by compressing a part of the grinding blade coupling portion in a thickness direction such that a groove is provided to a surface of the grinding blade coupling portion coupled to the grinding blade, wherein a step is formed between a surface of a part of the grinding blade coupling portion provided with the stiffness enhancement portion and a surface of a remaining part of the grinding blade coupling portion, wherein movement of the grinding blade coupled to the stiffness enhancement portion in a transverse direction of the grinding blade is restricted by a sidewall formed by the step.

Preferably, the stiffness enhancement portion is by performing pressure forging on a surface of the grinding blade coupling portion coupled to the grinding blade such that the surface of the grinding blade coupling portion coupled to the grinding blade has thickness reduced by 15% to 30% from thickness of the grinding blade coupling portion.

Preferably, the grinding blade is coupled to the grinding blade coupling portion by being welded on the stiffness enhancement portion.

In accordance with another aspect of the present invention, a method of manufacturing a stripping tip for orthodontics includes providing a grinding blade having a grinding surface for grinding teeth, providing a holder including a grinding blade coupling portion coupled to the grinding blade and a connection coupling portion connected to the grinding blade coupling portion and coupled to a handle or handpiece, forming a stiffness enhancement portion on a part of the grinding blade coupling portion coupled to the grinding blade to enhance stiffness of the part of the grinding blade coupling portion coupled to the grinding blade, and coupling the grinding blade to the stiffness enhancement portion.

Preferably, the forming of the stiffness enhancement portion includes performing pressure forging on a surface of the grinding blade coupling portion coupled to the grinding blade.

Preferably, the forming of the stiffness enhancement portion includes compressing a part of the grinding blade coupling portion in a thickness direction such that a groove is provided to a surface of the grinding blade coupling portion coupled to the grinding blade, wherein the coupling of the grinding blade includes coupling the grinding blade to the stiffness enhancement portion with the grinding blade inserted into the groove formed in the part of part of the grinding blade coupling portion provided with the stiffness enhancement portion.

Preferably, the forming of the stiffness enhancement portion includes performing pressure forging on a surface of the grinding blade coupling portion coupled to the grinding blade such that the surface of the grinding blade coupling portion coupled to the grinding blade has thickness reduced by 15% to 30% from thickness of the grinding blade coupling portion.

Preferably, the coupling of the grinding blade includes welding the grinding blade on the stiffness enhancement portion.

For a stripping tip for orthodontics according to an embodiment of the present invention, coupling between a holder and a grinding blade may be enhanced through a stiffness enhancement portion formed by pressure forging, and accordingly separation of the grinding blade may be effectively suppressed during grinding of teeth. In addition, the length of the grinding blade may be significantly increased compared to conventional cases, and therefore the length of stoke may be effectively increased for grinding of teeth.

As such, the present invention may provide high stability by effectively suppressing separation of the grinding blade during grinding of teeth, and effectively increase the length of stroke during grinding of teeth, thereby improving convenience and efficiency of the operation of grinding teeth.

### BRIEF DESCRIPTION OF THE DRAWINGS

FIG. 1 is a perspective view illustrating a stripping tip for orthodontics according to an embodiment of the present invention.

FIG. 2 is an exploded perspective view illustrating a stripping tip for orthodontics according to an embodiment of the present invention.

FIG. 3 is a cross-sectional view taken along line A-A of FIG. 2.

FIG. 4 is a cross-sectional view illustrating coupling between a grinding blade coupling portion and a grinding blade.

FIG. 5 is a flowchart illustrating a process of manufacturing a stripping tip for orthodontics according to an embodiment of the present invention.

FIG. 6 is a cross-sectional view showing the cross section of a grinding blade coupling portion.

FIG. 7 is a cross-sectional view illustrating the cross section of a grinding blade coupling portion provided with a stiffness enhancement portion.

FIG. 8 is a cross-sectional view illustrating coupling between a grinding blade and a stiffness enhancement portion.

### DETAILED DESCRIPTION

Reference will now be made in detail to embodiments of a stripping tip for orthodontic of the present invention, examples of which are illustrated in the accompanying drawings. It will be appreciated that for simplicity and clarity of illustration, the thicknesses of lines and the dimensions of some of the elements are exaggerated. The terms used in the following description are defined in consideration of functions of corresponding elements of the present invention and may be replaced by other terms based on intensions of the user or operator, customs, or the like. Therefore, the terms used herein should be construed based on the whole content of this specification.

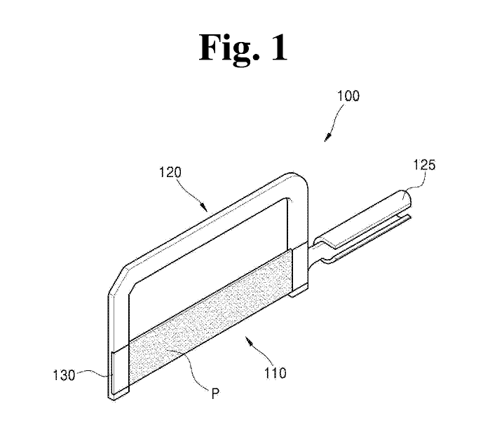

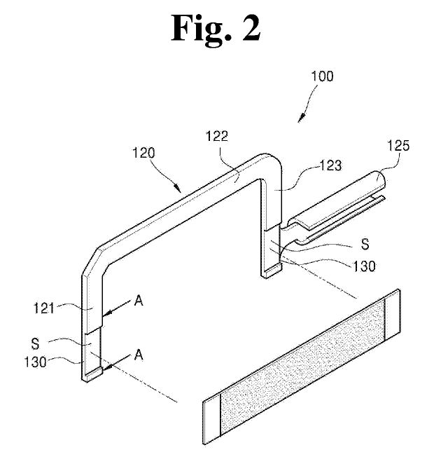

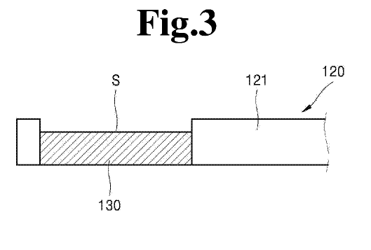

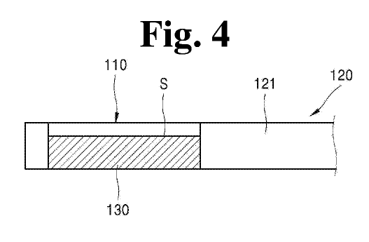

FIG. 1 is a perspective view illustrating a stripping tip for orthodontics according to an embodiment of the present invention, and FIG. 2 is an exploded perspective view illustrating a stripping tip for orthodontics according to an embodiment of the present invention. FIG. 3 is a cross-sectional view taken along line A-A of FIG. 2, and FIG. 4 is a cross-sectional view illustrating coupling between a grinding blade coupling portion and a grinding blade.

Referring to FIGS. 1 and 2, a stripping 100 for orthodontics according an embodiment includes a grinding blade 110, a holder 120 and a stiffness enhancement portion 130.

The grinding blade 110 is formed in the shape of a thin metal rod. The grinding blade 110 may be formed of a metallic material having high rigidity. The grinding blade 110 may be provided with a grinding surface p for grinding teeth.

The grinding surface p is formed on at least one of both surfaces of the grinding blade 110, namely one surface and opposite surface of the grinding blade 110 and is processed to have roughness like sandpaper. Thereby, the grinding surface p may grind teeth as it is rubbed against the teeth.

The grinding blade 110 is not limited to the illustrated shape. The grinding blade 110 may take various shapes according to the shape of teeth, a required amount of grinding of teeth, the purpose of use thereof, and the like.

The holder 120 is provided to hold the grinding blade 110, and is formed of a metallic material having high strength. The holder 120 includes a grinding blade coupling portion 121 and a connection coupling portion 125. In this embodiment, the holder 120 is illustrated as being formed of stainless metal.

The grinding blade coupling portion 121 defines a section corresponding to a portion of the holder 120 which is coupled to the grinding blade 110, and may be formed in the shape of a square bracket open downward.

That is, the grinding blade coupling portion 121 may be formed by connecting a horizontal frame 122 to a pair of vertical frames 121 and 123 which are spaced from each other.

The connection coupling portion 125 may extend from the vertical frame 123 in a horizontal direction, and be connected to the grinding blade coupling portion 121. The connection coupling portion 125 may be integrated with the grinding blade coupling portion 121.

The connection coupling portion 125 may be formed by bending a frame extending from the vertical frame 123 in a horizontal direction upwardly in the shape of “C”. The connection coupling portion 125 may be coupled to a handle (not shown) or handpiece (not shown) by fitting the portion into an insertion hole of the handle or handpiece.

The stiffness enhancement portion 130 is provided to a part of the grinding blade coupling portion 121 which is coupled to the grinding blade 110 to enhance stiffness of the part of the grinding blade coupling portion 121 which is coupled to the grinding blade 110.

According to this embodiment, the horizontal ends of the grinding blade 110 is coupled to the lower parts of the vertical frames 121 and 123 of the grinding blade coupling portion 121, and the stiffness enhancement portion 130 is provided to the coupling surfaces s of the grinding blade coupling portion 121 to which the ends of the grinding blade 110 are coupled.

The stiffness enhancement portion 130 configured as above is formed by performing pressure forging on the coupling surfaces s of the grinding blade coupling portion 121 coupled to the grinding blade 110.

That is, the coupling surfaces s of the grinding blade coupling portion 121 which correspond to a part of the vertical frames 121 and 133 are provided with the stiffness enhancement portion 130 through pressure forging by mechanically applying pressure to the coupling surfaces s in the thickness direction.

The stiffness enhancement portion 130 formed through pressure forging as described above is provided by compressing a part of the grinding blade coupling portion 121 in the thickness direction such that grooves are provide to the coupling surfaces s as shown in FIGS. 2 and 3.

That is, the grooves formed by compressing a part of the grinding blade coupling portion 121 in the thickness direction are positioned on the coupling surface s provided with the stiffness enhancement portion 130. Thereby, steps are formed between the surface of a part of the grinding blade coupling portion 121 provided with the stiffness enhancement portion 130, namely the coupling surfaces s and the surface of the remaining part of the grinding blade coupling portion 121.

In addition, due to the steps, sidewalls are formed between the coupling surfaces s of the grinding blade coupling portion 121 and the surface of the other part of the grinding blade coupling portion 121.

As shown in FIGS. 1 and 4, when the grinding blade 110 is coupled to the stiffness enhancement portion 130, transverse (hereinafter, referred to as “vertical”) movement of the grinding blade 110 may be restricted by the sidewalls formed as above.

Hereinafter, a description will be given of operation and effects of the stripping tip 100 for orthodontics according to this embodiment.

According to this embodiment, the holder 120 may be formed of stainless metal, and the stiffness enhancement portion 130 may be provided to parts of the grinding blade coupling portion 121 which are coupled to grinding blade 110. And the grinding blade 110 may be joined to the parts provided with the stiffness enhancement portion 130. Thereby, the grinding blade 110 may be coupled to the grinding blade coupling portion 121.

The grinding blade 110 may be joined to the stiffness enhancement portion 130 using a welding technique such as spot welding.

The stiffness enhancement portion 130 provided to the parts of the grinding blade coupling portion 121 which are coupled to the grinding blade 110 serves to enhance stiffness of the parts of the grinding blade coupling portion 121 which are coupled to the grinding blade 110.

That is, as the stiffness enhancement portion 130 is formed through pressure forging of mechanically applying pressure to the coupling surfaces s to which the grinding blade 110 is coupled, the coupling surfaces s are provided with stiffness higher than that of the other part around the coupling surfaces s with the thickness thereof reduced relative to the other part.

Preferably, the stiffness enhancement portion 130 may be formed by performing pressure forging on the coupling surfaces s of the grinding blade coupling portion 121 coupled to the grinding blade 110 such that the coupling surfaces s have thickness reduced by 15% to 30%, more preferably, by 20% from the thickness of the other part of the grinding blade coupling portion 121 around the coupling surfaces s.

If stainless metal of standard SUS 304 is used as a basic material of the grinding blade coupling portion 121, the tensile strength of the coupling surface s measured before pressure forging is about 520 N/mm². When pressure forging is performed on the material such that the thickness of the material is registered by 20%, it can be seen that the tensile strength of the part of the material subjected to pressure forging has increased by about 20% to about 620 N/mm².

That is, as pressure forging is performed on the coupling surface s of the grinding blade coupling portion 121 which is coupled to the grinding blade 110 such that the thickness of the coupling surface s is resisted by 20%, the tensile strength of the stiffness enhancement portion 130 may be increased by about 20% from the tensile strength of the other part of the grinding blade coupling portion 121 around the stiffness enhancement portion 130.

As the stiffness of the coupling surface s is enhanced due to the stiffness enhancement portion 130, coupling between the coupling surfaces s and the grinding blade 110 implemented through welding may be enhanced in proportion to the enhanced stiffness.

The extent to which pressure forging is applied to the coupling surface s to optimally form the stiffness enhancement portion 130 may depend on the thickness of the grinding blade coupling portion 121. Preferably, pressure forging is performed on the coupling surface s such that the thickness of the coupling surfaces s is reduced by 15% to 30%.

If the thickness by which the thickness of the coupling surface s is reduced through pressure forging is less than 15% of the original thickness of the coupling surface s, the rate of increase in the tensile strength is excessively low, and thus enhancement of stiffness of the stiffness enhancement portion 130 is not sufficiently achieved. If the thickness by which the thickness of the coupling surface s is reduced through pressure forging is greater than 30% of the original thickness of the coupling surface s, proper welding may not be implemented due to the excessively reduced thickness of the coupling surface s.

Additionally, as the stiffness enhancement portion 130 is formed on the coupling surfaces s through pressure forging as described above, a groove formed by compressing a part of the coupling portion 121 in the thickness direction thereof is positioned on the coupling surface s provided with the stiffness enhancement portion 130, and sidewalls are formed between the coupling surface s and the other part of the grinding blade coupling portion 121 due to steps formed therebetween.

As shown in FIGS. 1 and 4, when the grinding blade 110 is coupled to the stiffness enhancement portion 130, the vertical movement of the grinding blade 110 may be restricted by the sidewalls formed as above.

That is, since the grinding blade 110 coupled to the coupling surfaces s is supported by the sidewalls, force acting in the vertical direction may be effectively prevented from displacing the grinding blade 110 from the position thereof in the vertical direction, and coupling between the coupling surface s and the grinding blade 110 may be further enhanced.

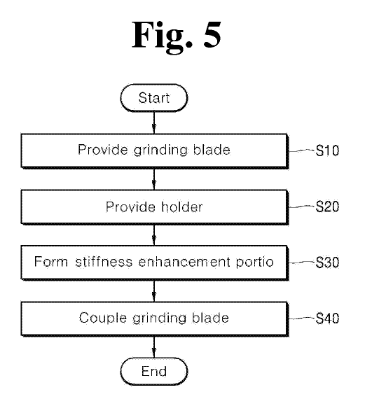

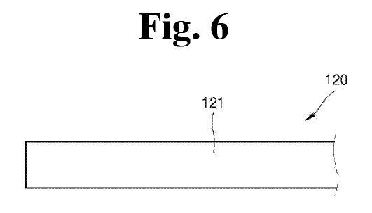

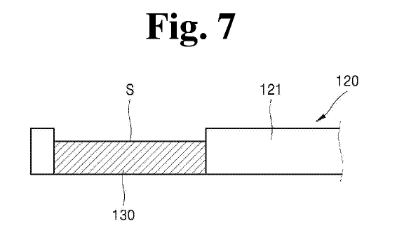

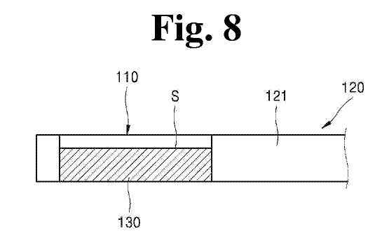

FIG. 5 is a flowchart illustrating a process of manufacturing a stripping tip for orthodontics according to an embodiment of the present invention, and FIG. 6 is a cross-sectional view showing the cross section of a grinding blade coupling portion. FIG. 7 is a cross-sectional view illustrating the cross section of a grinding blade coupling portion provided with a stiffness enhancement portion, and FIG. 8 is a cross-sectional view illustrating coupling between a grinding blade and a stiffness enhancement portion.

Hereinafter, a description will be given of a method for manufacturing a stripping tip for orthodontics according to an embodiment.

To manufacture a stripping tip 100 for orthodontics as shown in FIG. 1, a grinding blade 110 with grinding surfaces p for grinding teeth is provided as shown in FIGS. 2 and 5 (S10).

In this embodiment, the grinding blade 110 has a shape of a thin metal rod. The grinding blade 110 is formed of a metallic material having high rigidity, and is provided with the grinding surfaces p by processing both side surfaces of the grinding blade 110 to have roughness.

In addition, as shown in FIGS. 5 and 6, a holder 120 is provided such that a grinding blade coupling portion 121 to be coupled to the grinding blade 110 and a connection coupling portion 125 connected to the grinding blade coupling portion 121 and coupled to a handle or handpiece are formed (S20).

As a material for the holder 120, stainless metal which strongly resists against corrosion and provides high rigidity may be used.

Then, a stiffness enhancement portion 130 is provided to parts of the grinding blade coupling portion 121 which are coupled to the grinding blade 110 to enhance stiffness of the parts of the grinding blade coupling portion 121 coupled to the grinding blade 110, as shown in FIGS. 5 and 7 (S30).

The stiffness enhancement portion 130 is provided to coupling surfaces s of the grinding blade coupling portion 121 to which the ends of the grinding blade 110 are coupled. The coupling surfaces s of the grinding blade coupling portion 121 which is coupled to the grinding blade 110 is formed through pressure forging.

That is, the coupling surfaces s of the grinding blade coupling portion 121 which correspond to regions of the vertical frames 121 and 133 are provided with the stiffness enhancement portion 130 through pressure forging of mechanically applying pressure to the coupling surfaces s in the thickness direction.

The stiffness enhancement portion 130 may be provided through hot forging by heating the coupling surface s at a predetermined temperature and mechanically applying pressure to the coupling surface s to compress the coupling surface s or through cold forging by mechanically applying pressure to the coupling surface s to compress the coupling surface s without heating the coupling surfaces s.

Preferably, the stiffness enhancement portion 130 may be formed by performing pressure forging on the coupling surfaces s of the grinding blade coupling portion 121 coupled to the grinding blade 110 such that the coupling surfaces s have thickness reduced by 15% to 30%, more preferably, by 20% from the thickness of the other part of the grinding blade coupling portion 121 around the coupling surfaces s.

As stiffness of the coupling surfaces s is enhanced by the stiffness enhancement portion 130, which is formed through pressure forging, in proportion to the amount of decrease of the thickness of the coupling surfaces s, coupling between the coupling surfaces s and the grinding blade 110 implemented through welding may be enhanced in proportion to the enhanced stiffness.

Additionally, as the stiffness enhancement portion 130 is formed on the coupling surfaces s through pressure forging as described above, a groove formed by compressing a part of the coupling portion 121 in the thickness direction thereof is positioned on the coupling surface s provided with the stiffness enhancement portion 130, and sidewalls are formed between the coupling surface s and the other part of the grinding blade coupling portion 121 due to steps formed therebetween.

Once the stiffness enhancement portion 130 is formed, the grinding blade 110 is coupled to the coupling surfaces s provided with the stiffness enhancement portion 130 and shown in FIGS. 5 and 8 (S40).

According to this embodiment, the stiffness enhancement portion 130 may be provided to parts of the grinding blade coupling portion 121 which are coupled to grinding blade 110, and the grinding blade 110 may be joined to the parts provided with the stiffness enhancement portion 130. Thereby, the grinding blade 110 may be coupled to the grinding blade coupling portion 121.

The grinding blade 110 may be joined to the stiffness enhancement portion 130 using a welding technique such as spot welding.

As stiffness of the coupling surfaces s is enhanced by the stiffness enhancement portion 130 formed through pressure forging, coupling between the coupling surfaces s and the grinding blade 110 implemented through welding may be enhanced in proportion to the enhanced stiffness.

That is, due to the stiffness enhancement portion 130 formed through pressure forging, the grinding blade coupling portion 121 is further strongly coupled to the grinding blade 110.

In addition, since the grinding blade coupling portion 121 is coupled to the grinding blade 110 on the coupling surfaces s formed in the shape of a concave groove according to formation of the stiffness enhancement portion 130 thereon, the grinding blade 110 coupled to the coupling surfaces s is supported by the corresponding sidewalls, force acting in the vertical direction may be effectively prevented from displacing the grinding blade 110 from the position thereof in the vertical direction, and coupling between the coupling surface s and the grinding blade 110 may be further enhanced.

As coupling between the grinding blade coupling portion 121, namely the holder 120 and the grinding blade 110 is enhanced, the overall length of the stripping tip 100 for orthodontics including the grinding blade 110 and the holder 120 may be increased as necessary.

In conventional cases, the holder and the grinding blade are insufficiently coupled to each other, and thus the grinding blade is separated from the holder during work and the length of the grinding blade is limited.

That is, in conventional cases, the grinding blade is frequently separated from the holder during work, and the grinding blade is short. Accordingly, the stroke is short and grinding teeth is very inconvenient.

In contrast, with the stripping tip 100 for orthodontics according to this embodiment, coupling between the holder 120 and the grinding blade 110 is enhanced by the stiffness enhancement portion 130 formed through pressure forging. Accordingly, the grinding blade 110 may be effectively prevented from being separated from the holder during grinding of teeth, and the length of the grinding blade 110 may be significantly increased compared to the conventional cases. As a result, the length of stroke for grinding of teeth may be effectively increased.

Accordingly, the stripping tip 100 for orthodontics according to this embodiment may provide high stability by effectively suppressing separation of the grinding blade 110 during grinding of teeth, and improve convenient and efficiency of the teeth grinding operation by effectively increasing the length of stroke.

Although exemplary embodiments have been described above for illustrative purposes, it will be apparent to those skilled in the art that various modifications and variations can be made in the present invention without departing from the spirit or scope of the invention. Therefore, the scope of the present invention should be determined by the appended claims and their equivalents.

What is claimed is:

1. A stripping tip for orthodontics comprising:
a grinding blade provided with a grinding surface for grinding teeth;
a holder comprising a grinding blade coupling portion coupled to the grinding blade and a connection coupling portion connected to the grinding blade coupling portion and coupled to a handle or handpiece; and
a stiffness enhancement portion provided to a part of the grinding blade coupling portion coupled to the grinding blade to enhance stiffness of the part of the grinding blade coupling portion coupled to the grinding blade.

2. The stripping tip according to claim 1, wherein the stiffness enhancement portion is formed by performing pressure forging on a surface of the grinding blade coupling portion coupled to the grinding blade.

3. The stripping tip according to claim 1, wherein the stiffness enhancement portion is formed by compressing a part of the grinding blade coupling portion in a thickness direction such that a groove is provided to a surface of the grinding blade coupling portion coupled to the grinding blade,
wherein a step is formed between a surface of a part of the grinding blade coupling portion provided with the stiffness enhancement portion and a surface of a remaining part of the grinding blade coupling portion,
wherein movement of the grinding blade coupled to the stiffness enhancement portion in a transverse direction of the grinding blade is restricted by a sidewall formed by the step.

4. The stripping tip according to claim 1, wherein the stiffness enhancement portion is by performing pressure forging on a surface of the grinding blade coupling portion coupled to the grinding blade such that the surface of the grinding blade coupling portion coupled to the grinding blade has thickness reduced by 15% to 30% from thickness of the grinding blade coupling portion.

5. The stripping tip according to claims 1, wherein the grinding blade is coupled to the grinding blade coupling portion by being welded on the stiffness enhancement portion.

6. A method of manufacturing a stripping tip for orthodontics, the method comprising:
providing a grinding blade having a grinding surface for grinding teeth;
providing a holder comprising a grinding blade coupling portion coupled to the grinding blade and a connection coupling portion connected to the grinding blade coupling portion and coupled to a handle or handpiece;
forming a stiffness enhancement portion on a part of the grinding blade coupling portion coupled to the grinding blade to enhance stiffness of the part of the grinding blade coupling portion coupled to the grinding blade; and
coupling the grinding blade to the stiffness enhancement portion.

7. The method according to claim 6, wherein the forming of the stiffness enhancement portion comprises:
performing pressure forging on a surface of the grinding blade coupling portion coupled to the grinding blade.

8. The method according to claim 6, wherein the forming of the stiffness enhancement portion comprises:
compressing a part of the grinding blade coupling portion in a thickness direction such that a groove is provided to a surface of the grinding blade coupling portion coupled to the grinding blade,
wherein the coupling of the grinding blade comprises:
coupling the grinding blade to the stiffness enhancement portion with the grinding blade inserted into the groove formed in the part of part of the grinding blade coupling portion provided with the stiffness enhancement portion.

9. The method according to claim 8, wherein the forming of the stiffness enhancement portion comprises:
performing pressure forging on a surface of the grinding blade coupling portion coupled to the grinding blade such that the surface of the grinding blade coupling portion coupled to the grinding blade has thickness reduced by 15% to 30% from thickness of the grinding blade coupling portion.

10. The method according to claims 6, wherein the coupling of the grinding blade comprises:
welding the grinding blade on the stiffness enhancement portion.
